(19) United States
(12) Patent Application Publication
(10) Pub. No.: US 2008/0142605 A1
(43) Pub. Date: Jun. 19, 2008

(54) Marking device for a storage and/or transport container for medical equipment

(76) Inventor: Thomas Butsch, (US)

Correspondence Address: SCHROEDER & SIEGFRIED, P.A., 15600 WAYZATA BOULEVARD, SUITE 200, WAYZATA, MN, 55391, US

(21) Appl. No.: 12/002,461

(22) Filed: Dec. 17, 2007

(30) Foreign Application Priority Data
Dec. 18, 2006 (DE) 10 2006 060 176.9

(51) Int. Cl. G06K 19/00

(52) U.S. Cl. 235/492; 220/694

(57) ABSTRACT

The present invention discloses a marking device for a storage and/or transport container for medical devices with a mat made of sterilizable material and a marking element for storage of electronic information on characteristic parameters of the medical devices stored and/or transported in the storage and transport container, which can be read out in wireless fashion. An RFID tag can be used, for example, as marking element, in which information concerning sterilization processes, sterilization time and/or other parameters characteristic for the medical devices accommodated in the storage and/or transport container is stored.

### CROSS REFERENCE TO RELATED APPLICATION

Applicant claims priority under 35 U.S.C. §119 of German Patent Application No. 10 2006 060 176.9, filed on Dec. 18, 2006, the contents of which are incorporated herein by reference thereto.

### BACKGROUND OF THE INVENTION

The present invention pertains to a marking device for a storage and/or transport container for medical equipment.

It is known from the prior art to accommodate medical devices for and/or after sterilization for storage and/or transport in a storage and/or transport container. Marking of the container and/or the medical devices is then desirable in order to permit tracing.

It is known from the prior art to automatically identify (radio identification) and localize objects by radio frequency identification or RFID.

An RFID system then includes a transponder, also referred to as an RFID label, smart tag, smart label, snifter chip, RFID chip, RFID tag or radio label, read device with corresponding antenna and is integrated in a server, services or other systems, for example, point of sale systems or product inventory systems.

The transponder stores data that can be read without contact and without visual contact, depending on the design (passive/active, i.e., with a power supply via radio waves/with power supply by an integrated power source), employed frequency band, transmission power and environmental effects, to distances between a few centimeters and more than a kilometer. Data transmission between the transponder and reader occurs by means of electromagnetic waves. At low frequencies this occurs inductively via a near field, at high frequencies via an electromagnetic far field.

The basic structure and function of RFID tags is disclosed for example in U.S. Pat. Nos. 4,075,632, 4,360,801, 4,390,880, 4,739,328 and 5,030,807.

It is known from US 2006/0145871 A1 to identify sterilized medical devices situated within a sealed sterilization container before a surgical intervention. For this purpose an RFID tag is connected to each medical device and communicates information concerning the corresponding medical device via radio frequency to a RFID tag reader, which is situated outside of the sealed sterilization container consisting of a material that transmits electromagnetic energy, for example, radio frequency signals. Without opening the sealed sterilization container a user can thus obtain information concerning the contents of a sterilization container.

US 2006/0109105 A1 also discloses a transport container for medical devices in which each transport container has an RFID transponder tag and a barcode. The barcode contains information on the point of origin, the destination and optionally the content of the transport container, i.e., the identification number of each medical device contained in the transport container, whereas each set of medical devices contained in the transport container has an RFID tag. The RFID tag can contain information on the manufacturer, part number, series number and manufacturing date, use and storage and the like.

However, incorporation of RFID tags in each individual medical device is costly and in particular each new medical device must be equipped with an integrated RFID tag or retrofitting of RFID tags in already existing equipment is necessary.

In addition, there is interest in knowing the contents of the storage and/or transport container, optionally also its origin and/or destination, as well as the date of sterilization (since the medical devices only remain sterile for a predetermined time after sterilization) and/or external influences to which the storage and/or transport container was exposed.

### BRIEF SUMMARY OF THE INVENTION

One object of the present invention is therefore to design a marking device for a storage and/or transport container, by means of which simple, reliable and easy-to-read marking and tracing are possible.

According to the invention, this task is solved by a marking device for a storage and/or transport container for medical devices which comprises the features of claim 1, namely (a) a mat made of a sterilizable material; and (b) a marking element for storage of electronic information on characteristic parameters of medical devices stored and/or transported in the storage and transport container, which can be read out in wireless fashion. Advantageous modifications of the invention are mentioned in the dependent claims. An RFID tag can be used, for example, as the marking element, in which information concerning sterilization processes, sterilization time and/or other parameters characteristic for the medical devices accommodated in the storage and/or transport container is stored.

In this way the user can acquire, without significant expense, information concerning the content and history of a storage and/or transport container without having to open the container and is thus able to maintain sterility and track the storage and/or transport container.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 shows a marking device according to the invention for introduction into a storage and/or transport container,

FIG. 2 shows an alternative modification of the marking device according to the invention from FIG. 1,

FIG. 3 shows another alternative modification of the marking device from FIG. 1 according to the invention,

FIG. 4 shows an alternative practical example of a marking device according to the invention for introduction into a storage and/or transport container and

FIG. 5 shows another variant of a marking device according to the invention, whose size is adaptable to the corresponding storage and/or transport container.

### DETAILED DESCRIPTION OF THE INVENTION

The present invention will be described in detail below by means of practical examples of a marking device according to the invention for a storage and/or transport container.

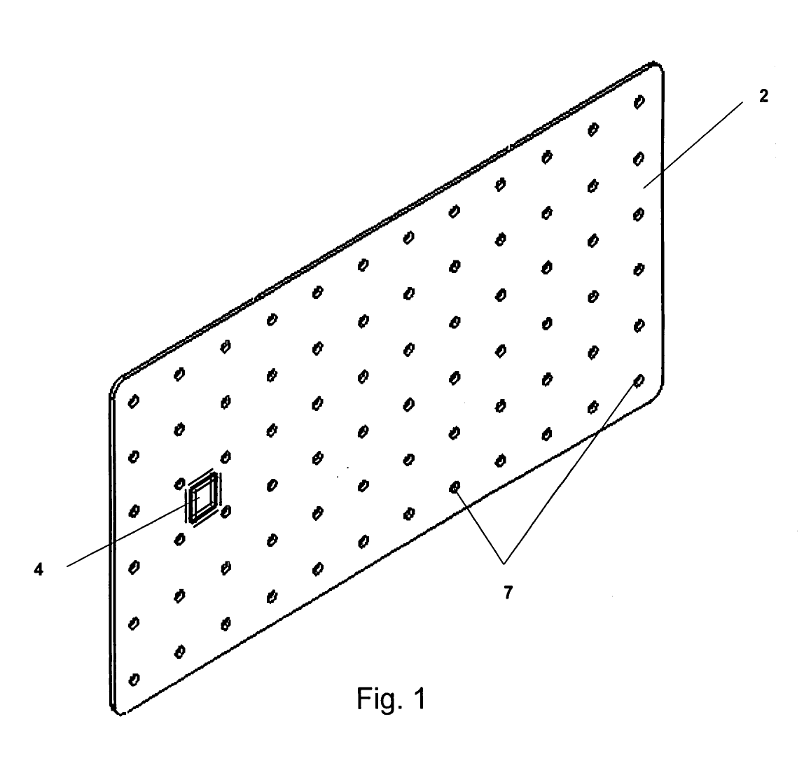

A marking device according to the invention for introduction into a storage and/or transport container is shown in FIG. 1. A marking device according to the invention consists of a mat 2 made of a sterilizable plastic material that can be inserted into a storage and/or transport container. One such material is silicone. The mat 2 preferably has through-holes 7 distributed over its surface through which water remaining after a sterilization process in the storage and/or transport container can flow out from the top of mat 2. The through-holes 7 can be formed either in a uniform pattern or in any arrangement in mat 2.

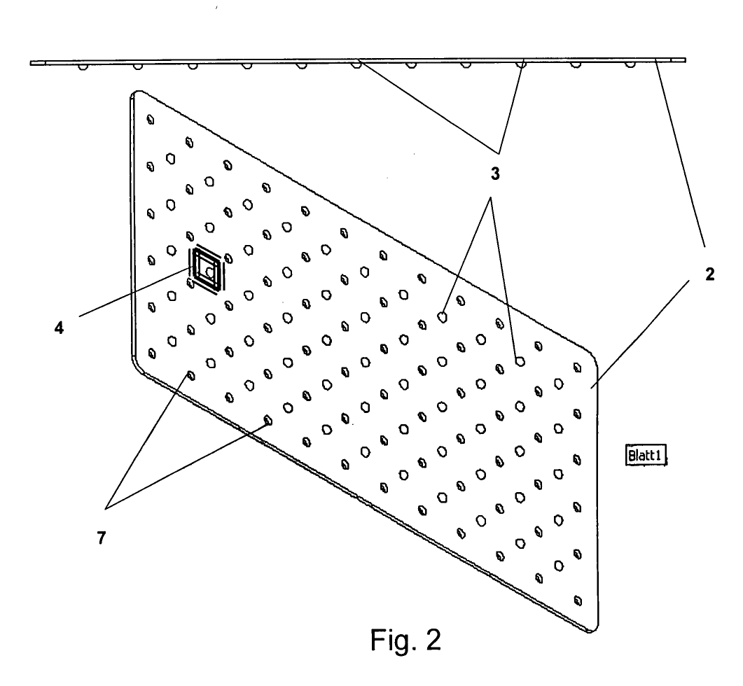

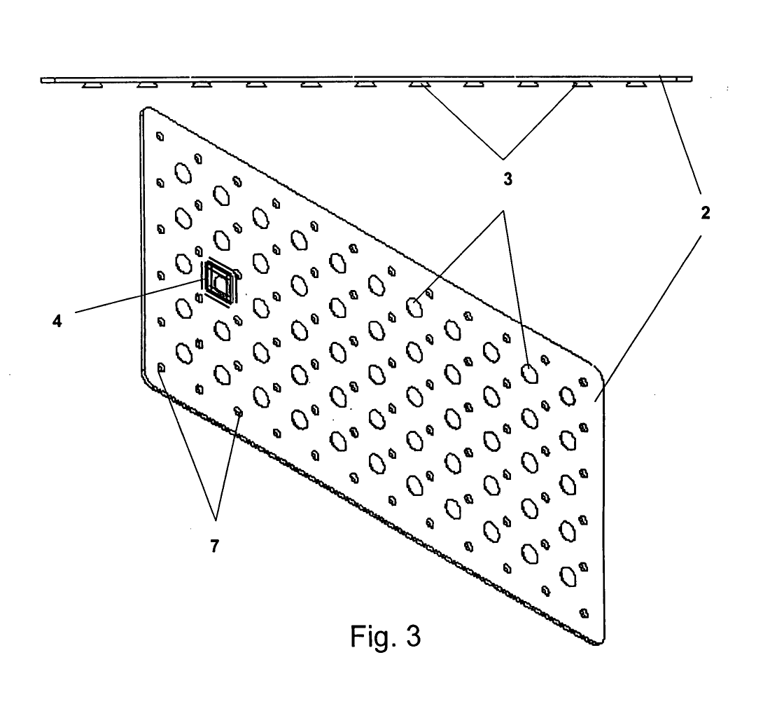

In a preferred modification of the marking device the mat 2 has spacers 3 on its side facing the inside surface of the storage and/or transport container, which can be formed, for example, as small knobs, as shown in FIG. 2, and/or as suction cups, as shown in FIG. 3. A predetermined spacing of mat 2 relative to the inside surface of the storage and/or transport container is guaranteed by the spacers 3 and therefore air circulation beneath the mat 2 between the mat 2 and the inside surface of the storage and/or transport container is permitted. In the preferred modification with spacers 3 in the form of suction cups, additional fastening of mat 2 in the storage and/or transport container can be dispensed with, since sliding is simply prevented on this account. In addition, simple replaceability of the mat 2 and therefore the marking device is also guaranteed. The spacers 3 are preferably formed in a uniform pattern; an arbitrary distribution, however, is also possible.

In this practical example according to FIG. 1 the surface of mat 2 is designed as a smooth surface on which medical devices to be stored and/or transported in the storage and/or transport container, like surgical instruments and/or implants, can be placed. The medical devices to be stored and/or transported are preferably arranged in a perforated insert (not shown), in which the marking element and therefore the smooth mat 2 is arranged between the inside wall of the storage and/or transport container and in perforated insert. In this way sliding of the medical devices on the smooth surface of mat 2 can be prevented and reliable accommodation of the medical devices is therefore made possible.

A marking element 4 is formed on the mat 2 preferably on the bottom, which contains electronic information, for example, concerning sterilization processes, sterilization time and/or other parameters characteristic for the medical devices accommodated in the storage and/or transport container. The marking element 4 can be glued to the bottom of the mat or connected to it in some other way. As an alternative the marking element 4 can also be integrated in mat 2.

The marking element 4 can also additionally have a marking field 4′, which is advantageously formed on the top of mat 2 and contains information directly readable for the user, for example, a series number. Preferably an RFID tag is used as a component of the marking element 4 for electronic storage of information, whose information can be read out without contact via a reading device (not shown). Both an active and passive RFID tag can be used whose properties were already discussed above, in which the passive RFID tag can be designed smaller because of the absence of a requirement for a power supply. As an alternative, another electronic component can be used as long as it permits storage of data and can be read out in wireless fashion.

In a modification of the invention the marking element 4 additionally has a device for recording and/or storing a temperature trend to which the storage and/or transport container including the medical devices contained in it was exposed. In this way, prior to use of the medical devices stored and/or transported in the storage/transport container it can now be reliably recognized whether the medical devices were exposed to influences and/or an unduly long period has elapsed, due to which sterilization is no longer reliably ensured.

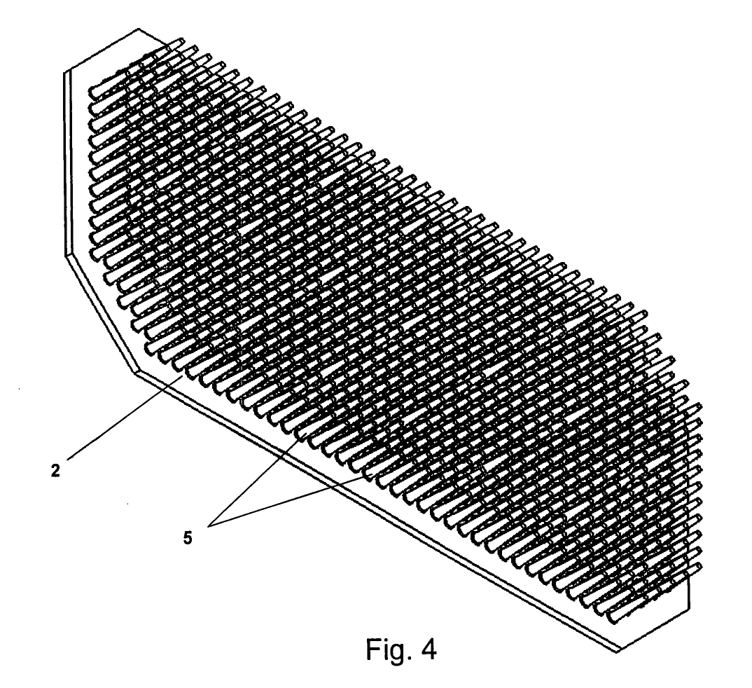

FIG. 4 shows an alternative practical example of a marking device according to the invention for introduction into a storage and/or transport container. In contrast to the marking device depicted in FIG. 1, the mat 2 here has not only spacers 3 on the side facing the inside of the storage and/or transport container, but also a number of knobs 5 on its top. The medical devices stored and/or transported in the storage and/or transport container 1 are situated on these knobs 5. The knobs 5 then serve, on the one hand, as a spacer, this time between mat 2 and the medical devices, which ensures ventilation between mat 2 and the medical devices and, on the other hand, because of their material, for example silicone, from which the mat 2 itself also is made, also as a cushion against vibrations during transport for the medical devices positioned on and/or in it. In this way damage to the stored and/or transported medical devices is avoided. In a preferred practical example the knobs 5 are designed pin-like; however, they can also be designed hemispherical.

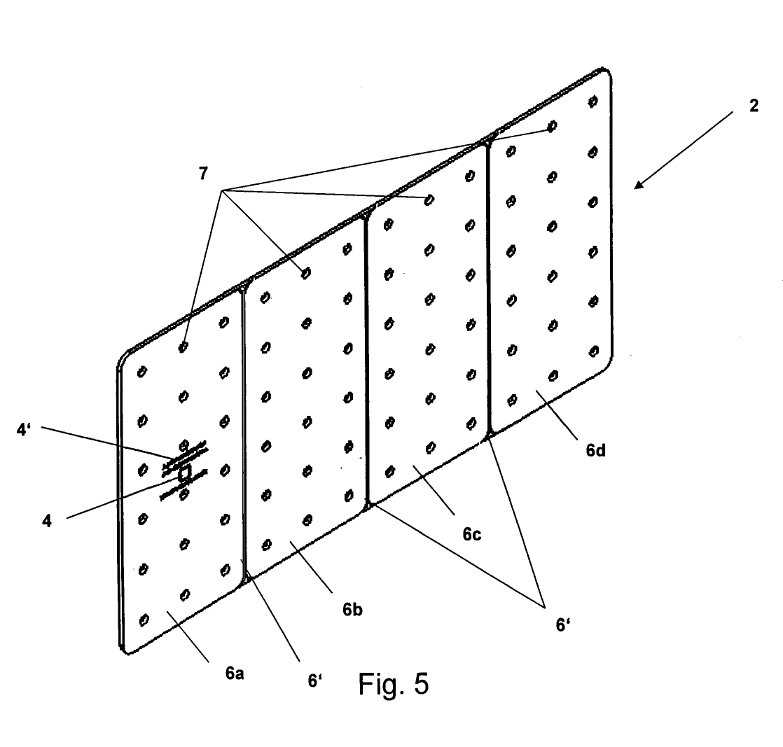

A modification of the present invention is shown in FIG. 5. FIG. 5 shows another variant of a marking device according to the invention whose size is adaptable to the corresponding storage and/or transport container. For this purpose the mat 2 is designed so that in a first partial area 6a the marking element 4 already described in detail in conjunction with FIG. 1 is provided. For this purpose additional partial areas 6b, 6c, 6d are formed, which are advantageously dimensioned so that the first partial area 6a either alone or in conjunction with one or more other partial areas 6b, 6c, 6d are suitable for fully covering the inside surface of the bottom of the storage and/or transport container. Between the individual partial areas 6a to 6d separation area 6′ can be formed in which separation of individual unrequired partial areas can occur.

It will, of course, be understood that various changes may be made in the form, details, arrangement and proportions of the parts without departing from the scope of the invention which comprises the matter shown and described herein and set forth in the appended claims.

1. Marking device for a storage and/or transport container for medical devices, comprising:
(a) a mat (2) made of a sterilizable material;
(b) a marking element (4) associated with said mat (2) for storage of electronic information on characteristic parameters of medical devices stored and/or transported in the storage and transport container, which can be read out in wireless fashion.

2. Marking device according to claim 1, characterized by the fact that the characteristic parameters contain information on sterilization processes, sterilization time and/or other parameters characteristic for the medical devices in the storage and/or transport container.

3. Marking device according to claim 1, characterized by the fact that the marking element (4) is formed on the bottom of mat (2).

4. Marking device according to claim 1, characterized by the fact that marking element (4) is fastened to the bottom of mat (2).

5. Marking device according to claim 3, characterized by the fact that fastening of the marking element (4) is formed by gluing.

6. Marking device according to claim 1, characterized by the fact that marking element (4) is integrated in mat (2).

7. Marking device according to claim 1, characterized by the fact that marking element (4) is an electronic component that permits wireless transmission of the information stored in it.

8. Marking device according to claim 7, characterized by the fact that the electronic component is an active RFID tag.

9. Marking device according to claim 7, characterized by the fact that the electronic component is a passive RFID tag.

10. Marking device according to claim 1, characterized by the fact that the sterilizable material is a plastic material.

11. Marking device according to claim 1, characterized by the fact that the sterilizable material is silicone.

12. Marking device according to claim 1, characterized by the fact that the mat (2) has through-holes (7).

13. Marking device according to claim 1, characterized by the fact that the mat (2) has spacers (3) on a side facing an inside surface of the storage and/or transport container.

14. Marking device according to claim 13, characterized by the fact that the spacers (3) are knobs and guarantee a predetermined spacing of mat (2) relative to the inside surface of the storage and/or transport container.

15. Marking device according to claim 1, characterized by the fact that mat (2) is arranged between an inside surface of the storage and/or transport container and a perforated insert of the storage and/or transport container.

16. Marking device according to claim 1, characterized by the fact that the mat (2) has a number of knobs (5) on its top.

17. Marking device according to claim 1, characterized by the fact that the mat (2) is designed dividable, in which the marking element (4) is present in a first partial area (6a) and at least one additional partial area (6b, 6c, 6d) is formed which is separable from the first partial area (6a).

18. Marking device according to claim 17, characterized by the fact that a separation area (6′) is formed between the partial areas (6a to 6d) in which a simple separation can occur.

19. Marking device according to claim 1, characterized by the fact that the marking element (4) additionally has a device to record and/or store a temperature trend to which the storage and/or transport container was exposed, including the medical device contained in it.

20. Marking device according to claim 1, characterized by the fact that the marking element (4) has a marking field (4′) formed on the top of mat (2) and contains information directly readable for the user.
